(19) United States
(12) Patent Application Publication
(10) Pub. No.: US 2009/0262480 A1
(43) Pub. Date: Oct. 22, 2009

(54) Electromagnetic actuating device with coils capable of holding electrification in series connection after being actuated in parallel connection

(76) Inventor: Tai-Her Yang, Dzan-Hwa (TW)

Correspondence Address: BACON & THOMAS, PLLC, 625 SLATERS LANE, FOURTH FLOOR, ALEXANDRIA, VA, 22314-1176, US

(21) Appl. No.: 12/081,721

(22) Filed: Apr. 21, 2008

(51) Int. Cl. H01H 51/30

(52) U.S. Cl. 361/154

(57) ABSTRACT

At least two sets of driving coils of the same individual electromagnetic actuating device of the present invention in parallel connection or series-parallel connection to appear relatively lower impedance being electrified to obtain larger actuating force is further manipulated by the switching device to be switched to series connection and series-parallel connection to appear relatively higher impedance thus reducing currents passing through driving coils, while required operating characteristics of the electromagnetic actuating device can still be satisfied.

### BACKGROUND OF THE INVENTION

(a) Field of the Invention

The present invention is mainly related to two or more than two sets of driving coils of the same individual electromagnetic actuating device being electrified to produce electromagnetic actuating effect, wherein two or more than two sets of driving coils of the same electromagnetic actuating device in parallel connection or series-parallel connection to appear relatively lower impedance is electrified wherein after the electromagnetic actuating device is actuated, said two or more than two sets of driving coils being manipulated by the switching device are switched to series connection or series-parallel connection to appear relatively higher impedance thus reducing current passing through driving coils, while required operating characteristics of the electromagnetic actuating device after electrification to electromagnetic actuation are still satisfied thereby saving electric power and reducing heat loss in the driving coils of the electromagnetic actuating devices.

(b) Description of the Prior Art

For the conventional electromagnetic actuating device driven by passing currents through driving coils to produce the electromagnetic actuating effect, the coil electrification status remains unchanged when the electrification status is actuated and held, i.e. the required excited currents for actuating and holding electrification are the same, therefore it has the disadvantages of the high heat loss and wasting electric energy.

### SUMMARY OF THE INVENTION

The present invention discloses an electromagnetic actuating device capable of holding electrification in series connection after being actuated in parallel connection, wherein two or more than two sets of driving coils of the same individual electromagnetic actuating device are installed, wherein it includes applications for normal close or normal open type electromagnetic brakes, normal close or normal open type electromagnetic clutches, normal close or normal open type electromagnetic switches, normal close or normal open type electromagnetic relays, normal close or normal open type solenoid valves, etc. as well as electromagnets, electromagnetic locks, spiral tube windings or other electromagnetic actuating devices with driving coils for electromagnetic driving effects, or operating type electromagnetic actuating devices which can be driven by driving coils or operated by numerous manual or mechanical power methods; wherein two or more than two sets of driving coils of the same individual electromagnetic actuating device is manipulated by the switching device to be electrically actuated in parallel connection or series-parallel connection with relatively lower impedance thereby to produce a larger electromagnetic actuating force, and further being manipulated by the switching device after actuation to switch said two or more than two sets of driving coils to series connection or series-parallel connection to appear relatively higher impedance thus reducing total currents passing through driving coils, while required operating characteristics of the electromagnetic actuating device after electrification can still be satisfied thereby saving electric power and reducing heat loss in the driving coils of the electromagnetic actuating device.

### BRIEF DESCRIPTION OF THE DRAWINGS

FIG. 1 is a circuit-block schematic view showing two driving coils of the same electromagnetic actuating device of the present invention is manipulated by the switching device for open or close, or for series or parallel connection.

FIG. 2 is a circuit schematic view showing that driving coils in FIG. 1 in parallel connection or series-parallel connection to appear relatively lower impedance are electrically actuated.

FIG. 3 is a circuit schematic view showing that driving coils in the embodiment of FIG. 1 in series connection or series-parallel connection to appear relatively higher impedance.

FIG. 4 which is a circuit-block schematic view showing that the electromagnetic actuating device is installed with a position detector device to operatively control the driving coils.

### DESCRIPTION OF MAIN COMPONENT SYMBOLS

101: Switching Device
102: Electromagnetic actuating device
103, 113: Surge absorption device
102′, 112′: Driving coil
105: Position detector device
Ia, Ib, Ic: Excited current

### DETAILED DESCRIPTION OF THE PREFERRED EMBODIMENTS

The present invention is related to the two or more than two sets of driving coils of the same individual electromagnetic actuating device being manipulated by a switching device, wherein it includes applications for normal close or normal open type electromagnetic brakes, normal close or normal open type electromagnetic clutches, normal close or normal open type electromagnetic switches, normal close or normal open type electromagnetic relays, normal close or normal open type solenoid valves, etc. as well as electromagnets, electromagnetic locks, spiral tube windings or other electromagnetic actuating devices with driving coils for electromagnetic driving effects, or operating type electromagnetic actuating devices which can be driven by driving coils or operated by numerous manual or mechanical power methods; wherein two or more than two sets of driving coils of the same electromagnetic actuating device are manipulated by the switching device to be electrically actuated in parallel connection or series-parallel connection with relatively lower impedance thereby to produce a larger electromagnetic actuating force, and further being manipulated by the switching device after actuation to switch said two or more than two sets of driving coils to series connection or series-parallel connection to appear relatively higher impedance thus reducing total currents passing through driving coils, while required operating characteristics of the electromagnetic actuating device after electrification can still be satisfied thereby saving electric power and reducing heat loss in the driving coils of the electromagnetic actuating device.

The embodiment of the electromagnetic actuating device installed with two driving coils is described in the following:

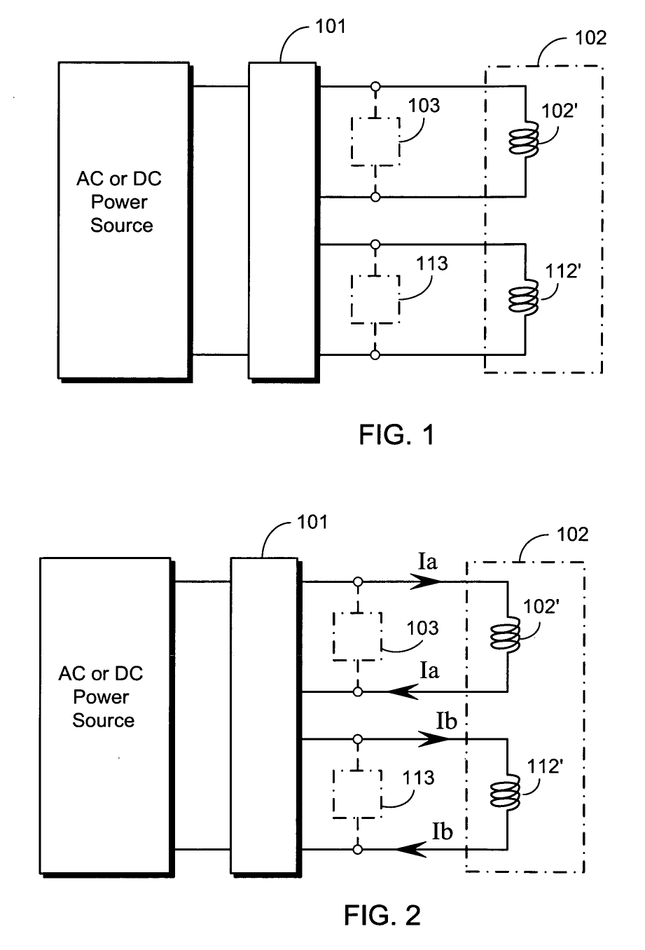

FIG. 1 is a circuit-block schematic view of an embodiment showing two sets of driving coils of the same electromagnetic actuating device of the present invention are manipulated by the switching device for open or close, or for series or parallel connection, wherein it mainly comprises:

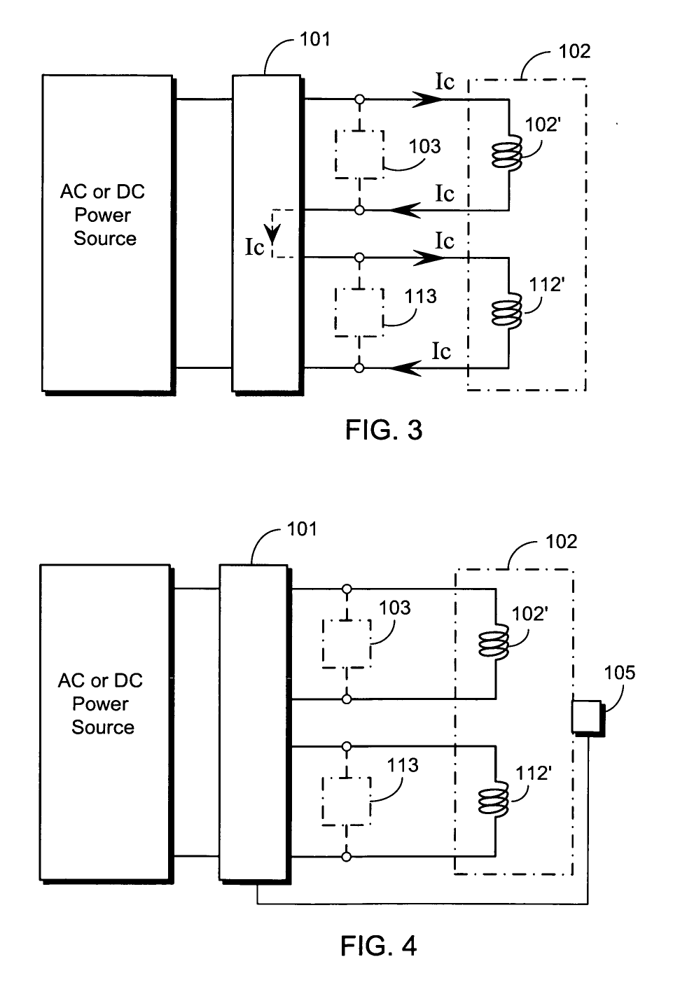

A switching device (101): It is constituted by an electromechanical switch, an electric relay, an electromagnetic switch or a solid state switching device, etc operable by the manual, mechanical, fluid or electrical power, wherein it is operated by the manual, mechanical, fluid or electrical power that through supplying AC or DC power to at least two sets of driving coils (102′, 112′) installed in the same electromagnetic actuating device (102) to provide a switching function for electrification and power cut-off, or it is through the switchover operation by the switching device (101) to make the at least two sets of driving coils (102′, 112′) of the electromagnetic actuating device in parallel connection or series-parallel connection to appear relatively lower impedance to pass excited currents (Ia) and (Ib) respectively. FIG. 2 is a circuit schematic view showing that driving coils in FIG. 1 in parallel connection or series-parallel connection to appear relatively lower impedance are electrically actuated, wherein after the parallel connection or series-parallel connection to appear relatively lower impedance being electrically actuated, it is manipulated by the switching device (101) to switch said driving coils (102′, 112′) to appear relatively higher impedance in series connection or series-parallel connection thereby allowing smaller excited current (Ic) to commonly pass through series-connected driving coils (102′, 112′). FIG. 3 is a circuit schematic view showing that driving coils in the embodiment of FIG. 1 in series connection or series-parallel connection to appear relatively higher impedance, wherein when the series connection or series-parallel connection to appear relatively higher impedance is electrified, required characteristics of the actuating operating status of the electromagnetic actuating device in electrification shall still be satisfied by the electromagnetic effective force of the electromagnetic actuating device.

The electromagnetic actuating device capable of holding electrification in series connection after being actuated in parallel connection, wherein at least two sets of driving coils (102′, 112′) installed in the same individual electromagnetic actuating device is manipulated by the switching device, whereof the switching modes to switch from parallel connection or series-parallel connection that appearing relatively lower impedance to series connection or series-parallel connection that appearing relatively higher impedance include:
(1) At least two driving coils (102′, 112′) of the same individual electromagnetic actuating device are manipulated by manual-sequential operating switching device (101) for switch between parallel connection or series-parallel connection that appearing relatively lower impedance and series connection or series-parallel connection that appearing relatively higher impedance thereby holding electrification for excitation; or
(2) At least two driving coils (102′, 112′) of the same individual electromagnetic actuating device in parallel connection or series-parallel connection to appear relatively lower impedance are manipulated by the switching device (101) with time delay control function to provide a time delay and to be switched to series connection or series-parallel connection to appear relatively higher impedance thereby holding electrification for excitation; or
(3) By detecting current values passing through the switching device (101) to driving coils (102′, 112′) of the same electromagnetic actuating device, when the electrified actuating excited current value of two or more than two sets of driving coils (102′, 112′) of the same electromagnetic actuating device □ the setting current value, or □ the status of setting current value exceeding over the setting time, the switching device (101) is driven to switch said driving coils (102′, 112′) to series connection or series-parallel connection that appearing relatively higher impedance thereby holding electrification for excitation; or
(4) The switching device (101) is driven by two or more than two methods of the above said (1) (2) (3) to execute the manipulation;

The electromagnetic actuating device (102): It is constituted by at least two AC or DC powered driving coils (102′, 112′) to be installed in the same individual device which includes conventional normal close or normal open type electromagnetic brakes, normal close or normal open type electromagnetic clutches, normal close or normal open type electromagnetic switches, normal close or normal open type electromagnetic relays, normal close or normal open type solenoid valves, etc. as well as electromagnets, electromagnetic locks, spiral tube windings or other electromagnetic actuating devices with driving coils for electromagnetic driving effects, or operating type electromagnetic actuating devices which can be driven by driving coils or operated by numerous manual or mechanical power methods; wherein by the manipulation of the switching device (101), it is electrically actuated in parallel connection or series-parallel connection to appear relatively lower impedance and is switched to series connection thereby saving electric energy and reducing heat generation; wherein when the series connection or series-parallel connection is electrified for excitation, required operating characteristics of the electromagnetic actuating device in electrification status are still satisfied;

Said individual driving coils (102′, 112′) can be optionally constituted by conducting wires of the same or different material or of the same or different conduction cross-section areas, or constituted by windings with the same or different numbers of coils.

The surge absorption devices (103, 113): The AC or DC surge absorption devices being optionally installed according to specifications of electromagnetic actuating devices are respectively parallel connected with driving coils (102′, 112′) to help absorbing the produced inductance of counter-electric potential in driving coils (102′, 112′) when said driving coils (102′, 112′) are operated by the switching device (101) to open or close, or to be parallel connected or series-parallel connected to appear relatively lower impedance, or to be switched to relatively higher impedance in series connection or series-parallel connection, wherein the surge absorption device is constituted by the following: (1) When driving coils (102′, 112′) are powered by AC power, the AC surge absorption device (103) installed can be constituted by a bipolar solid state varistor, or constituted by at least two kinds of components of the resistors, inductors, bipolar capacitors, etc. in series connection, parallel connection, or series-parallel connection, or constituted by the bipolar capacitor alone, or constituted by other conventional AC surge absorption circuit devices; (2) When driving coils (102′, 112′) are powered by the DC power with lower voltage, the DC surge absorption device (113) installed can be constituted by reverse polarity diodes in parallel connection to appear a flywheel diode with energy storage effect, or constituted by at least two kinds of components of the resistors, inductors, uni-polar or bipolar capacitors in series connection, parallel connection, or series-parallel connection, or constituted by the uni-polar or bipolar capacitor alone, or constituted by the solid state varistor or other conventional DC surge absorption devices; wherein this device can be optionally installed or not installed as required.

In practical applications, wherein the two or more than two sets of driving coils installed in the same individual electromagnetic actuating device of the electromagnetic actuating device with coils capable of holding electrification in series connection after being actuated in parallel connection of the present invention can be constituted by driving coils with the same or different electromechanical characteristics.

For the electromagnetic actuating device with coils capable of holding electrification in series connection after being actuated in parallel connection of the present invention, the switching method of the at least two sets of driving coils (102′, 112′) installed in the same individual electromagnetic actuating device to switch from parallel connection or series-parallel connection that appearing relatively lower impedance to series connection or series-parallel connection that appearing relatively higher impedance is further as shown in FIG. 4 which is a circuit-block schematic view showing that the electromagnetic actuating device is installed with a position detector device to manipulate driving coils; wherein the position detector device (105) is installed at a stable position after relative actuation between the rotor and the stator of the electromagnetic actuating device or at a selected position in the stroke of actuation, so that driving coils (102′, 112′) of the electromagnetic actuating device in parallel or series-parallel connection to appear relatively lower impedance being electrified to the selected position is through the position detector device (105) to directly switch the at least two driving coils (102′, 112′) of the same individual electromagnetic actuating device from parallel connection or series-parallel connection that appearing relatively lower impedance to series connection or series-parallel connection that appearing relatively higher impedance; or said at least two driving coils (102′, 112′) in parallel connection or series-parallel connection that appearing relatively lower impedance is manipulated by the switching device (101) which is further subjected to the control of the position detector device (105) to be switched to series connection or series-parallel connection to appear relatively higher impedance;

The position detector device (105) can be constituted by pressure sensing type electromechanical switching devices or pressure-actuating spring leaf type switches, or can be constituted by optical, electromagnetic inducing type, capacitive inducing type or other conventional position sensing devices, wherein this device can be optionally installed or not installed as required.

As summarized from the above descriptions, at least two driving coils installed in the same individual electromagnetic actuating device of the electromagnetic actuating device with coils capable of holding electrification in series connection after being actuated in parallel connection can be electrified in parallel connection or series-parallel connection to appear relatively lower impedance so as to obtain larger actuating power and actuating response characteristics, wherein it is characteristically further through manipulation by the switching device to switch said at least two sets of driving coils to series connection or series-parallel connection to appear relatively higher impedance thus reducing total currents passing through driving coils, while required operating characteristics of the electromagnetic actuating device in electrification by the electromagnetic effective force can still be satisfied thereby saving electric power and reducing heat generation of the electromagnetic actuating device.

1. An electromagnetic actuating device with coils capable of holding electrification in series connection after being actuated in parallel connection is through the switching device to manipulate the two or more than two sets of driving coils installed in the same individual electromagnetic actuating device to be electrically actuated in parallel connection or series-parallel connection to appear relatively lower impedance thereby to produce a larger electromagnetic actuating force, and further being manipulated by the switching device after actuation to switch said two or more than two sets of driving coils to series connection or series-parallel connection to appear relatively higher impedance thus reducing total currents passing through driving coils, while required operating characteristics of the electromagnetic actuating device after electrification can still be satisfied thereby saving electric power and reducing heat loss in the driving coils of the electromagnetic actuating device, wherein it mainly comprises:
A switching device (101): it is constituted by an electromechanical switch, an electric relay, an electromagnetic switch or a solid state switching device, etc operable by the manual, mechanical, fluid or electrical power, wherein it is operated by the manual, mechanical, fluid or electrical power that through supplying AC or DC power to at least two sets of driving coils (102′, 112′) installed in the same electromagnetic actuating device (102) to provide a switching function for electrification and power cut-off, or it is through the switchover operation by the switching device (101) to make the at least two sets of driving coils (102′, 112′) of the electromagnetic actuating device in parallel connection or series-parallel connection to appear relatively lower impedance to pass excited currents (Ia) and (Ib) respectively, wherein after the parallel connection or series-parallel connection to appear relatively lower impedance being electrically actuated, it is manipulated by the switching device (101) to switch said driving coils (102′, 112′) to appear relatively higher impedance in series connection or series-parallel connection thereby allowing smaller excited current (Ic) to commonly pass through series-connected driving coils (102′, 112′), wherein when the series connection or series-parallel connection to appear relatively higher impedance is electrified, required characteristics of the actuating operating status of the electromagnetic actuating device in electrification shall still be satisfied by the electromagnetic effective force of the electromagnetic actuating device;
The electromagnetic actuating device (102): it is constituted by at least two AC or DC powered driving coils (102′, 112′) to be installed in the same individual device for electromagnetic driving effects, or operating type electromagnetic actuating devices which can be driven by driving coils or operated by numerous manual or mechanical power methods; wherein by the manipulation of the switching device (101), it is electrically actuated in parallel connection or series-parallel connection to appear relatively lower impedance and is switched to series connection thereby saving electric energy and reducing heat generation; wherein when the series connection or series-parallel connection is electrified for excitation, required operating characteristics of the electromagnetic actuating device in electrification status are still satisfied.

2. The electromagnetic actuating device with coils capable of holding electricity in series connection after being actuated in parallel connection as claimed in claim 1, wherein at least two sets of driving coils (102′, 112′) installed in the same individual electromagnetic actuating device is manipulated by the switching device whereof the switching modes to switch from parallel connection or series-parallel connection that appearing relatively lower impedance to series connection or series-parallel connection that appearing relatively higher impedance include:
(1) At least two driving coils (102′, 112′) of the same individual electromagnetic actuating device are manipulated by manual-sequential operating switching device (101) for switch between parallel connection or series-parallel connection with relatively lower impedance to series connection or series-parallel connection with relatively higher impedance thereby holding electrification for excitation; or
(2) At least two driving coils (102′, 112′) of the same individual electromagnetic actuating device in parallel connection or series-parallel connection to appear relatively lower impedance are manipulated by the switching device (101) with time delay control function to provide a time delay and to be switched to series connection or series-parallel connection to appear relatively higher impedance thereby holding electrification for excitation; or
(3) By detecting current values passing through the switching device (101) to driving coils (102′, 112′) of the same electromagnetic actuating device, when the electrified actuating excited current value of two or more than two sets of driving coils (102′, 112′) of the same electromagnetic actuating device □ the setting current value, or □ the status of setting current value exceeding over the setting time, the switching device (101) is driven to switch said driving coils (102′, 112′) to series connection or series-parallel connection that appearing relatively higher impedance thereby holding electrification for excitation; or
(4) The switching device (101) is driven by two or more than two methods of the above said (1) (2) (3) to execute the manipulation.

3. The electromagnetic actuating device with coils capable of holding electricity in series connection after being actuated in parallel connection as claimed in claim 1, wherein the individual driving coils (102′, 112′) can be optionally constituted by conducting wires of the same or different material or of the same or different conduction cross-section areas, or constituted by windings with the same or different numbers of coils.

4. The electromagnetic actuating device with coils capable of holding electricity in series connection after being actuated in parallel connection as claimed in claim 1, wherein two or more than two sets of driving coils installed in the same individual electromagnetic actuating device is constituted by driving coils with the same or different electromechanical characteristics.

5. The electromagnetic actuating device with coils capable of holding electricity in series connection after being actuated in parallel connection as claimed in claim 1, wherein the switching method of the at least two sets of driving coils (102′, 112′) installed in the same individual electromagnetic actuating device to switch from parallel connection or series-parallel connection that appearing relatively lower impedance to series connection or series-parallel connection that appearing relatively higher impedance, and wherein the position detector device (105) is installed at a stable position after relative actuation between the rotor and the stator of the electromagnetic actuating device or at a selected position in the stroke of actuation, so that driving coils (102′, 112′) of the electromagnetic actuating device in parallel or series-parallel connection to appear relatively lower impedance being electrified to the selected position is through the position detector device (105) to directly switch the at least two driving coils (102′, 112′) of the same individual electromagnetic actuating device from parallel connection or series-parallel connection that appearing relatively lower impedance to series connection or series-parallel connection that appearing relatively higher impedance; or said at least two driving coils (102′, 112′) in parallel connection or series-parallel connection that appearing relatively lower impedance is manipulated by the switching device (101) which is further subjected to the control of the position detector device (105) to be switched to series connection or series-parallel connection to appear relatively higher impedance;
The position detector device (105) can be constituted by pressure sensing type electromechanical switching devices or pressure-actuating spring leaf type switches, or can be constituted by optical, electromagnetic inducing type, capacitive inducing type or other conventional position sensing devices, wherein this device can be optionally installed or not installed as required.

6. The electromagnetic actuating device with coils capable of holding electricity in series connection after being actuated in parallel connection as claimed in claim 5, wherein the AC or DC surge absorption devices being optionally installed according to specifications of electromagnetic actuating devices are respectively parallel connected with driving coils (102′, 112′) to help absorbing the produced inductance of counter-electric potential in driving coils (102′, 112′) when said driving coils (102′, 112′) are operated by the switching device (101) to open or close, or to be parallel connected or series-parallel connection, or to be switched to relatively higher impedance in series connection or series-parallel connection, wherein the surge absorption device is constituted by the following:
(1) When driving coils (102′, 112′) are powered by AC power, the AC surge absorption device (103) installed can be constituted by a bipolar solid state varistor, or constituted by at least two kinds of components of the resistors, inductors, bipolar capacitors, etc. in series connection, parallel connection, or series-parallel connection, or constituted by the bipolar capacitor alone, or constituted by other conventional AC surge absorption circuit devices;
(2) When driving coils (102′, 112′) are powered by the DC power with lower voltage, the DC surge absorption device (113) installed can be constituted by reverse polarity diodes in parallel connection to appear a flywheel diode with energy storage effect, or constituted by at least two kinds of components of the resistors, inductors, uni-polar or bipolar capacitors in series connection, parallel connection, or series-parallel connection, or constituted by the uni-polar or bipolar capacitor alone, or constituted by the solid state varistor or other conventional DC surge absorption devices; wherein this device can be optionally installed or not installed as required.

7. The electromagnetic actuating device with coils capable of holding electricity in series connection after being actuated in parallel connection as claimed in claim 1, wherein two or more than two sets of driving coils of the same individual electromagnetic actuating device is manipulated by the switching device, wherein it includes applications for normal close or normal open type electromagnetic brakes, normal close or normal open type electromagnetic clutches, normal close or normal open type electromagnetic switches, normal close or normal open type electromagnetic relays, normal close or normal open type solenoid valves, etc. as well as electromagnets, electromagnetic locks, spiral tube windings or other electromagnetic actuating devices with driving coils for electromagnetic driving effects, or operating type electromagnetic actuating devices which can be driven by driving coils or operated by numerous manual or mechanical power methods.
